(19) United States
(12) Patent Application Publication
(10) Pub. No.: US 2009/0124146 A1
(43) Pub. Date: May 14, 2009

(54) Ship propulsion unit and ship propulsion method

(76) Inventors: Reinhold Reuter, Schwall (DE); Manfred Heer, Landkern (DE); Peter Jansen, Urbar (DE)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/916,940

(22) PCT Filed: Jun. 9, 2006
(86) PCT No.: PCT/DE06/00993

§ 371 Date: Jun. 3, 2008

(30) Foreign Application Priority Data
Jun. 9, 2005 (DE) 20 2005 009 075.1
Jul. 1, 2005 (DE) 20 2005 010 385.3
Jul. 13, 2005 (DE) 20 2005 011 057.4
Aug. 31, 2005 (DE) 20 2005 013 752.9

(51) Int. Cl. B63H 23/02; H02K 55/00

(52) U.S. Cl. 440/75; 505/166

(57) ABSTRACT

The invention relates to a ship propulsion unit with drive devices in the hull and all underwater pod, which is located outside of the hull and which has a front propeller and a rear propeller as well as torque transmitting devices between the drive devices and the propellers. The torque transmitting devices contain: a torque transmitting shalt that is shared by both propellers and serves to transmit torque from the drive devices into the underwater pod; front transmission devices, which are placed in the underwater pod and which are located between the shared torque transmitting shaft or both propellers and the front propeller, and; rear transmission devices that are located between the shared torque transmitting shaft of both propellers and the rear propeller. The invention also relates to a ship propulsion method during which a front propeller and a rear propeller, which are assigned to an underwater pod located outside of the hull, are driven by drive devices in the hull via torque transmitting devices. Both propellers are driven via: a torque transmitting shaft, which is contained in the torque transmitting devices, shared by both propellers, and which serves to transmit torque from the drive devices to the underwater pod; front transmission devices, which are placed in the underwater pod and which are located between the shared torque transmitting shaft of both propellers and the front propeller, and; rear transmission devices that are located between the shared torque transmitting shaft of both propellers and the rear propeller.

The present invention relates to a double-propeller drive and to a double-propeller drive method for ships, as well as to a ship propulsion unit with a high-temperature superconductor motor.

Such double-propeller drives or twin-propeller drives by the applicant have been successfully placed on the market in known constructions up to outputs of 2000 kW. For larger applications, according to the construction, due to the large diameter of a required ring gear, which must transfer the torque of the propeller at the rotational speed of the propeller, the underwater pod diameter becomes so large that a considerable amount of the good efficiency is lost.

The present invention has and realizes the objective of improving double-propeller drives and double-propeller drive methods. The present invention further has and realizes the objective of improving double-propeller drives and double-propeller drive methods for ships, as well as ship propulsion units with a high-temperature superconductor motor. Specifically, the invention has and realizes the objective of improving double-propeller drives with a high-temperature superconductor motor, so that good efficiency remains at high outputs. The invention further has and realizes, in particular, the objective of improving ship propulsion units with a high-temperature superconductor, so that a high output to the propeller or propellers is achieved with simple means while maintaining good efficiency.

These goals are achieved with a ship propulsion unit according to claim 1 and also a ship propulsion method according to claim 24.

Accordingly, the invention creates a ship propulsion unit comprising drive devices in the hull and an underwater pod located outside of the hull with a front propeller and a rear propeller, as well as torque-transmitting devices between the drive devices and the propellers, wherein the torque-transmitting devices contain a torque-transmitting shalt that is shared by both propellers for transmitting torque from the drive devices to the underwater pod and front transmission devices, which are placed in the underwater pod and which are located between the shared torque-transmitting shaft of both propellers and the front propeller, as well as rear transmission devices that are located between the shared torque-transmitting shaft of both propellers and the rear propeller.

Preferably, it is further provided that only one fraction of the torque is transmitted via the torque-transmitting shaft to the two propellers at a corresponding rotational speed, wherein via the torque-transmitting shaft preferably only approximately 15% to approximately 40%, especially approximately 20% to approximately 35%, and preferably approximately 25% to approximately 30% of the torque is transmitted to the two propellers at the corresponding rotational speed.

Furthermore, at least one ring gear-bevel gear pair is assigned to the torque-transmitting shaft for reversing the direction of rotation and only a fraction of the torque is transmitted to the two propellers at the corresponding rotational speed via the one or more ring gear-bevel gear pair. Here, advantageously via the one or more ring gear-bevel gear pair, only approximately 15% to approximately 40%, especially approximately 20% to approximately 35%, and advantageously approximately 25% to approximately 30% of the torque can be transmitted to both propellers at the corresponding rotational speed.

Preferably, the front transmission devices contain a front planetary gear and/or the real transmission devices contain a rear planetary gear. Here, it is further preferred when the front planetary gear and/or the rear planetary near contain/contains a gear reduction for achieving at least approximately the full torque at the corresponding propeller. Alternatively or additionally, it can be provided that the front planetary gear and/or the rear planetary gear have/has a gear reduction of approximately 2 to approximately 5, especially approximately 2.5 to approximately 4.5, and preferably approximately 3 to approximately 4.

In another preferred construction the front transmission devices contain a front ring gear and an associated front pinion gear, which is engaged with this front ring gear and which is coupled to the torque-transmitting shaft, and/or that the rear transmitting devices contain a rear ring gear and an associated rear pinion gear, which is engaged with this rear ring gear and which is coupled to the torque-transmitting shaft, wherein, in particular, the front pinion gear and/or the rear pinion gear lie or lies on the torque-transmitting shaft and preferably the front pinion gear and/or the rear pinion gear are or is locked in rotation with the torque-transmitting shaft. An alternative or additional refinement is achieved in that the front ring gear-bevel gear pair and/or the rear ring gear-bevel gear pair contain or contains gear reduction for achieving at least approximately the full torque to the corresponding propeller, wherein advantageously the front ring gear-pinion gear pair and/or the rear ring gear-rear pinion gear pair have or has a gear reduction of approximately 2 to approximately 5, especially approximately 2.5 to approximately 4.5, and preferably approximately 3 to approximately 4.

In the ship propulsion unit according to the invention, it can be further provided that the front transmission devices and the rear transmission devices are designed so that the two propellers rotate in the same direction or that the front transmission devices and the rear transmission devices are designed so that the two propellers rotate opposite each other or that direction of rotation reversing devices acting on at least one of the two propellers are provided, by means of which it can be adjusted so that the two propellers rotate in the same or opposite directions.

Another preferred refinement consists in that the front transmission devices and the rear transmission devices are designed so that the two propellers rotate at different speeds, wherein, in particular, the front transmission devices and the rear transmission devices are designed so that the rear propeller rotates faster than the front propeller.

It is further preferred when there are rotational speed control devices acting oil at least one of the two propellers, by means of which the rotational speed ratio between the two propellers can be adjusted. Another similarly preferable construction consists in that a differential transmission is located between the torque-transmitting shaft and the two propellers.

The ship propulsion unit according to the invention can be further improved advantageously such that the two propellers have parallel or coaxial rotational axes, which are at a non-90° angle to the vertical, so that the front propeller lies lower than the rear propeller. In a refinement of this construction, it is further preferred that the smaller angle of the rotational axes of the two propellers to the vertical equals approximately 80° to approximately 89°, especially approximately 82° to approximately 87°, and preferably at least approximately 85°.

Especially advantageous is the combination of any preceding constructions with the further advantageous feature, according to which the drive devices contain a high-temperature superconductor motor.

Through the invention, a ship propulsion method is further created, wherein a front propeller and a rear propeller, which are assigned to an underwater pod placed outside of the hull, are driven by drive devices in the hull via torque-transmitting devices and wherein the two propellers are driven via a torque-transmitting shaft contained in the torque-transmitting devices and shared by both propellers for transmitting torque from the drive devices to the underwater pod and via front transmission devices, which are located in the underwater pod and which are placed between the shared torque transmission shaft of the two propellers and the front propeller, as well as rear transmission devices, which are placed between the shared torque-transmitting shalt of the two propellers and the rear propeller.

This can be advantageously improved in that only a fraction of the torque is transmitted to the two propellers at the corresponding rotational speed via the torque transmission shaft, wherein furthermore, in particular, via the torque transmission shaft only approximately 15% to approximately 40%, especially approximately 20% to approximately 35%, and preferably approximately 25% to approximately 30% of the torque is transmitted to the two propellers at the corresponding rotational speed.

Furthermore, it is preferred if at least one ring gear-bevel gear pair is assigned to the torque-transmitting shaft for reversing the direction of rotation and if only a fraction of the torque is transmitted to the two propellers at the corresponding rotational speed via the one or more ring gear-bevel gear pair, wherein, in addition, preferably via the one or more ring gear-bevel gear pair, only approximately 15% to approximately 40%, especially approximately 20% to approximately 35%, and advantageously approximately 25% to approximately 30% of the torque is transmitted to the two propellers at the corresponding rotational speed.

It is also preferred that the front transmission devices contain a front planetary gear and/or that the rear transmission devices contain a rear planetary gear, and that through the front planetary gear and/or the rear planetary gear a gear reduction is performed for reaching at least approximately the full torque to the corresponding propeller, and/or that through the front planetary gear and/or the rear planetary gear, a gear reduction takes place from approximately 2 to approximately 5, especially approximately 2.5 to approximately 4.5, and advantageously approximately 3 to approximately 4.

Another prefer-red construction of the ship propulsion method according to the invention consists in that the front transmission devices contain a front ring gear and an associated front pinion gear, which is engaged with this front ring gear and which is coupled to the torque-transmitting shaft, and/or that the rear transmission devices contain a rear ring gear and an associated rear pinion gear, which is engaged with this rear ring gear and which is coupled to the torque-transmitting shaft, and that the front pinion gear and/or the rear pinion gear lie or lies on the torque-transmitting shaft. Additional preferred constructions consist in that the front pinion gear and/or the rear pinion gear are rotated identically to the torque-transmitting shaft, and/or that through the front ring gear-front pinion gear pair and/or the rear ring gear-rear pinion gear pair, gear reduction is realized for delivering at least approximately the full torque to the corresponding propeller, wherein, especially by the front ring gear-front pinion gear pair and/or the rear ring gear-rear pinion gear pair, gear reduction of approximately 2 to approximately 5, especially approximately 2.5 to approximately 4.5, and preferably approximately 3 to approximately 4 is realized.

It can be advantageously provided that the front transmission devices and the rear transmission devices are designed so that the two propellers rotate in the same direction or that the front transmission devices and the rear transmission devices are designed so that the two propellers rotate in opposite directions or that there are direction of rotation reversing devices acting on at least one of the two propellers, by means of which it is adjusted that the two propellers rotate in the same or opposite directions.

It is further preferred when the front transmission devices and the rear transmission devices are designed so that the two propellers rotate at different speeds, wherein, in particular, the front transmission devices and the rear transmission devices are designed so that the rear propeller rotates faster than the front propeller.

Another preferred construction consists in that there are rotational speed control devices acting on at least one of the two propellers, by means of which a rotational speed ratio between the two propellers is adjusted. Alternatively or additionally it can be advantageously provided that a differential transmission is located between the torque-transmitting shaft and the two propellers, through which the different rotational speeds between the front propeller and the rear propeller are set.

In the ship propulsion method it can be further advantageously provided that the two propellers have parallel or coaxial rotational axes, which are at a non-90° angle to the vertical, so that the front propeller lies lower than the rear propeller, this can be refined, in particular, in that the smaller angle of the rotational axes of the two propellers to the vertical equals approximately 80° to approximately 89°, especially approximately 82° to approximately 87°, and advantageously approximately at least 85°.

It is further especially advantageous in the ship propulsion method according to the invention when the drive devices contain a high-temperature superconductor motor, through which the torque-transmitting shaft is driven.

Accordingly, the invention creates, in particular, a ship propulsion unit, which is constructed as a double-propeller drive comprising drive devices in the hull and two at least essentially coaxial propellers, which are assigned to an underwater pod, as well as torque-transmitting devices between the drive devices and the propellers, wherein the torque-transmitting devices contain a ring gear-bevel gear pair in the underwater pod for transmitting only a portion of the torque, as well as a planetary gear assigned to each propeller within the underwater pod with gear reduction for delivering at least approximately the full torque to the propellers.

Preferably, the two, in particular, at least essentially coaxial propellers are mounted so that they can rotate on or in the underwater pod.

Furthermore, the invention creates, in particular, also a ship propulsion method in the form of a double-propeller drive method, wherein torque is transmitted from the drive devices in the hull to two at least essentially coaxial propellers on an underwater pod, and wherein furthermore, from the drive devices only a portion of the torque is transferred via a ring gear-bevel gear pair in the underwater pod to at least one planetary gear assigned to each propeller within the underwater pod, with which gear reduction for delivering at least approximately the full torque to the propellers is realized.

Furthermore, the invention preferably creates a ship propulsion unit with a double-propeller drive comprising drive devices, which contain a high-temperature superconductor motor in the hull and two at least essentially coaxial propellers on an underwater pod, as well as torque-transmitting devices between the drive devices and the propellers, wherein the torque-transmitting devices contain a ring gear-bevel gear pair in the underwater pod for transmitting only a portion of the torque, as well as a planetary gear assigned to each propeller within the underwater pod with gear reduction for delivering at least approximately the full torque to the propellers.

Additional preferred and/or advantageous constructions of the invention emerge from the claims and their combinations, as well as all of the present application documents.

The invention is explained in more detail below using embodiments with reference to the drawing merely as examples, in which

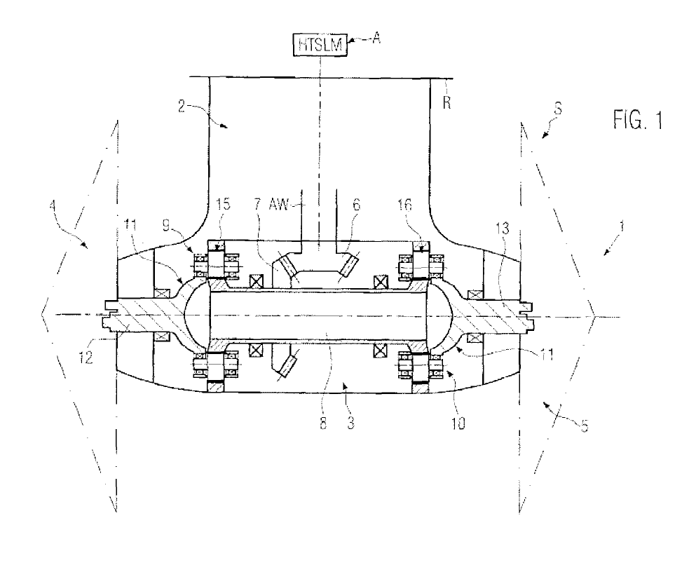

FIG. 1 shows a schematic of a first embodiment of a double-propeller drive in a longitudinal section and

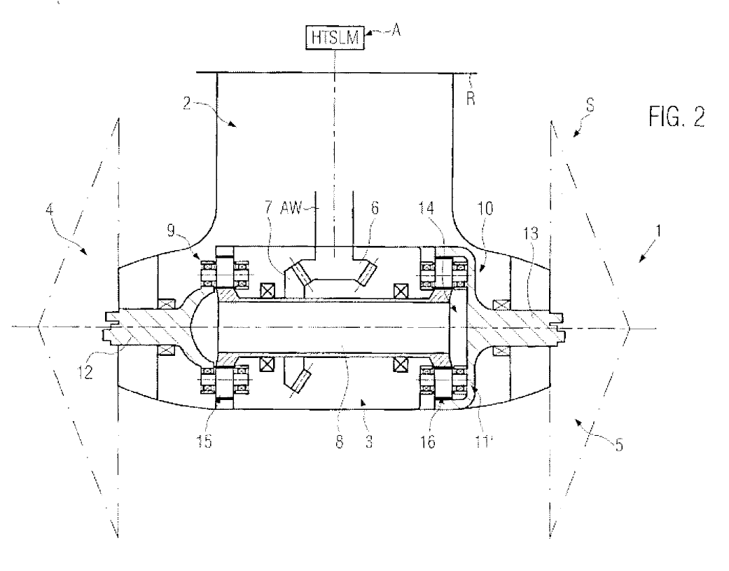

FIG. 2 shows a schematic of a second embodiment of a double-propeller drive in a longitudinal section,

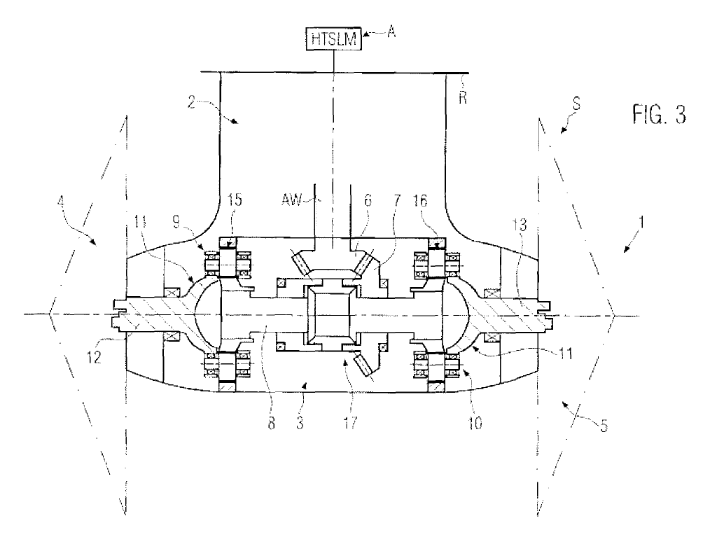

FIG. 3 shows a schematic of a third embodiment of a double-propeller drive in a longitudinal section, and

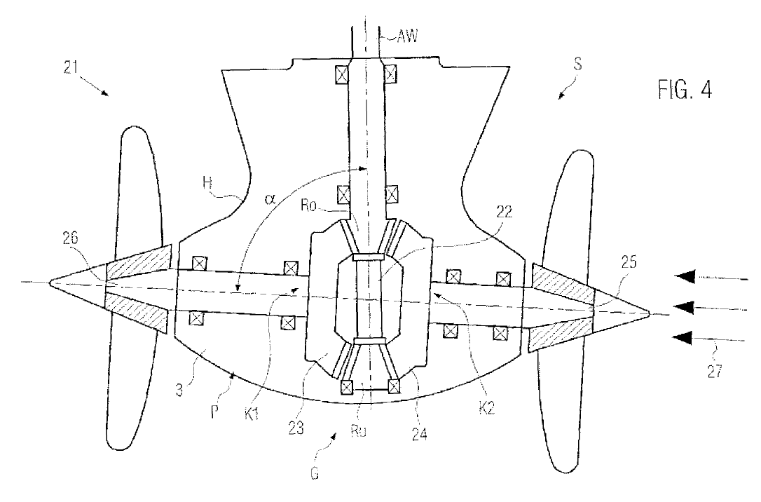

FIG. 4 shows a schematic of a fourth embodiment of a double-propeller drive in a longitudinal section.

The invention will be explained in more detail using the constructions and embodiments described below and shown in the drawings merely as examples, i.e. the invention is not limited to these constructions and embodiments or to the combination of features within these embodiments and constructions. Method and apparatus features also emerge analogously from method and apparatus descriptions.

Individual features, which are specified and/or illustrated in connection with an actual embodiment, are not limited to this embodiment or the combination with the other features of this embodiment, but instead can be combined within the scope of technical possibilities, with other variants, also when they are not separately discussed in the present documents.

Identical reference symbols in the individual figures and images of the drawing designate identical or similar components with identical or similar functions. With reference to the representations in the drawing, those features that are not provided with reference symbols also become clear, independently of whether or not those features are described below. On the other hand, features contained in the present description but not visible or illustrated in the drawing can also be easily understood by someone skilled in the art.

FIG. 1 shows schematically, in longitudinal section, a first embodiment of a ship propulsion unit S in the form of a double-propeller drive 1, which is also designated as a twill propeller drive.

The double-propeller drive 1 contains a pear-shaped underwater pod 2 with an underwater gear 3 housed in this pod, as well as two propellers 4 and 5. The rear propeller 4 pointing in the direction toward the stern of the ship (not shown) is to be considered as the rear propeller 4 and the front propeller 5 pointing in the direction toward the bow of the ship is to be considered accordingly as the front propeller 5.

The underwater gear 3 contains a ring gear 6 and a bevel gear 7 on an axle 8 leading to each propeller 4 and 5, in order to transmit torque from drive devices A arranged in a hull R, from which the underwater pod 2 extends downward, to the two propellers 4 and 5 via the underwater gear 3.

According to the invention, now via the ring gear-bevel gear pair 6, 7 in the underwater gear 3, for example, in particular only 25-30% of the torque is transmitted to the propellers 4 and 5 at the corresponding rotational speed. Trough the arrangement of planetary gears 9 and 10 with gear reduction from 3 to 4, the necessary propeller torque at the corresponding rotational speed is first achieved before the propellers 4 and 5. Different gear reductions of the planetary gears 9 and 10 allow an optimum propeller design.

In the embodiment according to FIG. 1, the two planet wheel stages contain, in a typical way, sun wheels, planet wheels, and ring gears, as well as a planet carrier 11 which are connected to each driveshaft 12 and 13, on which the propellers 4 and 5, respectively, are arranged. The construction, as well as the effect and function of such planetary gears 9 and 10, are known, in principle, to those skilled in the art, so that a detailed explanation is unnecessary here. Furthermore, any constructions known from the technical field of planetary gears can be used in connection with the present ship propulsion unit S or double-propeller drive 1 at the discretion of those skilled in the art.

Through the construction according to the invention, a smaller diameter of the pear shape of the underwater gear 3 can be realized in comparison with conventional constructions, which provides better efficiency for the system. Also, different rotational speeds of the propellers 4 and 5 are possible, which allows a more advantageous propeller design. Lower rotational speeds and larger torques on the propellers 4 and 5 are possible, without the disadvantage of a large ring gear diameter.

For the previously explained embodiment according to FIG. 1, a version with counter-running propellers 4 and 5 is possible, wherein a planetary gear 10 is constructed with fixed planet carrier 11′ and the connection from a ring gear 14 to the propeller shaft 13 is constructed as shown in the schematic section view of FIG. 2, wherein parts that are identical or similar to those shown in FIG. 1 are provided with the same reference symbols and are not explained again here in order to avoid repetition. Instead, the reader is referred to the descriptions concerning FIG. 1.

For this design, with the variation of the rotational speeds and the direction of rotation in connection with the small diameter of the pear shape, the prerequisites for an increase in efficiency of twin-propellers systems of more than 5% relative to previous conventional constructions are possible.

For the sake of completeness, with reference to all of the embodiments specified in the present document, the two planetary gear stages 15 and 16 are also mentioned, which have a typical construction with sun wheels, planet wheels, and ring gears and which therefore do not need to be further explained here.

With reference to FIG. 3, below another embodiment of a ship propulsion unit S or double-propeller drive 1 will be explained. As far as this double-propeller drive 1 according to the third embodiment shown in FIG. 3 has the same components and functions as the first embodiment, which is shown in FIG. 1 and which was explained above with reference to this figure these components and functions will not be discussed again below, but instead only those components and functions that differ from the first embodiment according to FIG. 1 will be discussed in order to avoid simple repetition. With regard to the matching components and functions in the first and third embodiments, the reader is referred to the preceding description concerning the first embodiment according to FIG. 1.

In the third embodiment of a ship propulsion unit S or double-propeller drive 1 shown in FIG. 3 in a schematic longitudinal section, a differential gear 17, which is also designated as an equalizing gear is provided between the two propellers 4 and 5. Through the arrangement of the differential gear 17, the load is balanced between the two propellers 4 and 5, which brings or holds the load on the two propellers 4 and 5 in all operating situations to the same level. The differential gear 17, which is provided in the double-propeller drive 1 according to the third embodiment shown in FIG. 3, is constructed and designed to be used in connection with propellers 4 and 5 running in the same direction with planetary gears 9 and 10. Without restrictions, however, it is also possible to realize the construction and design of the differential gear 17 so that such a differential gear 17 can be used for an arrangement with propellers 4 and 5 running in the opposite direction.

The construction and also the effect and function of such a differential or equalizing gear 17 is known, in principle, to someone skilled in the art, so that a detailed explanation is unnecessary here. Furthermore, any constructions known from the technical field of differential or equalizing (ears can be used in connection with the present double-propeller drive 1 at the discretion of those skilled in the art.

The variant of the ship propulsion unit S or double-propeller drive 1 with a differential or equalizing gear 17 can also be realized for double or twin-propeller drives 1 with only one bevel-gear stage in the underwater gear 3 between the ring gear-bevel gear pair 6 and the two propellers 4 and 5. This can be implemented, for example, by dividing the axle 8, which is likewise the axial connection of the two propeller shafts 12 and 13.

Another such independent aspect of the present invention as well as simultaneously also another variant of the embodiments explained above consists in that the drive devices contain at least one high-temperature superconductor motor HTSLM, which is housed in the hull. Such a high-temperature superconductor motor HTSLM is powered with electrical power, for example, by a diesel-electric system.

In principle, a high-temperature superconductor motor HTSLM has good efficiency but requires, in order to be able to achieve correspondingly high outputs that are required at the propeller or the propellers, a large and thus very expensive system. Through the present invention, in the scope of this independent aspect to be described now and also a related embodiment, which is also to be considered as a construction and/or refinement of the other aspects of the present invention, it is possible for the high-temperature superconductor motor HTSLM to have a smaller construction than would otherwise be necessary for a conventional construction for an essentially direct line transmission to the propeller or propellers. Here, because essentially general technical teaching is used according to the embodiments explained in connection with the figures of the drawing, the general description and especially the description related to the figures and embodiments in this regard are incorporated to their full extent in the present explanation, in order to avoid simple repetition. Furthermore, because a graphical illustration is not required for understanding the additional technology to be described now, no illustration is provided.

The other claimed independent aspect of the present invention, as well as simultaneously also the other variants of the previously explained embodiments consist in that, as was already described above, the drive devices contain at least one high-temperature superconductor motor HTSLM, which is housed in the hull. An essential feature here is also a gear increase by torque transmission devices, which are connected between the drive devices and the propeller or propellers. These torque transmission devices are provided, as also stated in the other embodiments of the drive devices, in the underwater pod, where parts of these torque transmission devices are housed, which also can be realized, for example, in other constructions very generally, but do not absolutely have to be realized in this way.

Preferably, the torque transmission devices according to one embodiment contain a ring gear-bevel gear pair in the underwater pod for transmitting only a portion of the torque as well as a planetary gear assigned to each propeller within the underwater pod with gear reduction for delivering at least approximately the full torque to the propellers. In this way, a significantly smaller high-temperature superconductor motor HTSLM can be used in comparison with a variant without the gear increase realization. Due to the specific requirements of a high-temperature superconductor motor HTSLM, this is of very decisive advantage, first, for exploiting the advantages of a high-temperature superconductor motor HTSLM and, second and mainly, for the basic application of a high-temperature superconductor motor HTSLM in the ship propulsion field, i.e., for a mobile application limited in terms of space and also power.

A smaller high-temperature superconductor motor HTSLM has the advantage that the cooling requirements are tower. In this way, first, the application of a high-temperature superconductor motor HTSLM on a ship is possible for the first time or is at least considerably simplified, in principle, and, second, the tasks for the “smalller” high-temperature superconductor motor HTSLM are overall significantly smaller than for a larger, i.e., in particular, higher-power variant of a high-temperature superconductor motor HTSLM. In this way, in an especially advantageous way, a significantly more favorable realization of the application of a high-temperature superconductor motor HTSLM on a ship is achieved. According to the invention, a high-temperature superconductor motor HTSLM with a small torque can be used, because a higher torque, which can be nevertheless achieved at relatively low expense with a small high temperature superconductor motor HTSLM in connection with the gear increase in the torque-transmitting devices, compensates the torque, for example, in the underwater gear. For example through the construction with the planetary gear named above, a high torque is available at the propeller or propellers. Thus, in comparison with a high-power motor in the small high-temperature superconductor motor HTSLM, through which the same power can be provided by a high rotational speed, but at a smaller torque, through the gear according to the invention, a necessary high torque can be provided in the torque-transmitting devices at the propeller or the propellers.

In a fourth embodiment of a ship propulsion unit S or double-propeller drive 21 shown schematically and partially cut away in FIG. 4 with a propulsion unit P, the drive is realized via a driveshaft AW preferably vertically. The force transmission is then split in a pod housing H of the underwater pod 3 between an upper and a lower pinion gear Ro and Ru, respectively. The two pinion gears Ro and Ru each engage in only one of two ring gears 23 and 24, respectively, which each form one of two bevel gear stages K1 or K2 with their associated pinion gear Ro and Ru.

These two separate bevel gear transmission stages K1 and K2 can be realized. e.g. through an axle angle α less than 90°, through the use of an equalizing shaft 22 for compensating angular or radial axle offsets between the two pinion gears Ro and Ru or also through correspondingly different gear diameters. The use of an angle α less than 90° produces the positive effect that the pod G is inclined in the direction of flow shown symbolically by the arrows 27. The advantageous and therefore especially preferred angle α of 85° corresponds well to the typical angles of flow for stern propulsion units in ships.

Therefore, because the power to be transferred is divided at two gears and these gear stages K1 and K2 can also have different gear ratios, the system of the double-propeller drive 21 has a very small construction in terms of pod diameter and can be optimized at low rotational speeds for the front propeller 25 freely receiving a flow and correspondingly higher rotational speed can be constructed for the rear propeller 26 operating in the accelerated flow.

In addition, the design allows the realization of large outputs for mechanical rudder propellers for the use of typical, achievable gear-set dimensions.

Method and apparatus features also emerge, as already specified above, analogously from the device and apparatus descriptions, respectively.

The invention has been explained using the embodiments merely as examples in the description and in the drawing and is not limited to these embodiments, but instead includes all variations, modifications, substitutions, and combinations that someone skilled in the art can infer from the present document, especially within the scope of the claims and the general specifications in the introduction of this description, as well as the description of the embodiments, and can be combined with technical knowledge from this field as well as from the state of the art. In particular, all of the individual features and possible constructions of the invention and its embodiments can be combined.

1. Ship propulsion unit comprising drive devices in the hull and an underwater pod placed outside of the hull with a front propeller and a rear propeller, as well as torque-transmitting devices between the drive devices and the propellers, characterized in that the torque-transmitting devices contain a torque-transmitting shaft shared by both propellers for transmitting torque from the drive devices into the underwater pod and front transmission devices, which are arranged in the underwater pod and which are located between the shared torque-transmitting, shaft of the two propellers and the front propeller, and also rear transmission devices, which are located between the shared torque-transmitting shaft of the two propellers and the rear propeller.

2. Ship propulsion unit according to claim 1, characterized in that only a fraction of the torque is transmitted via the torque-transmitting shaft to the two propellers at the corresponding rotational speed.

3. Ship propulsion unit according to claim 2, characterized in that via the torque-transmitting shaft only approximately 15% to approximately 40%, especially approximately 20% to approximately 35%, and preferably approximately 25% to approximately 30% of the torque is transmitted to the two propellers at the corresponding rotational speed.

4. Ship propulsion unit according to one of the preceding, claims, characterized in that at least one ring gear-bevel gear pair is assigned to the torque-transmitting shalt for reversing the direction of rotation and that only a fraction of the torque is transmitted to the two propellers at the corresponding rotational speed via the one or more ring gear-bevel gear pairs.

5. Ship propulsion unit according to claim 4, characterized in that via the one or more ring gear-bevel gear pairs, only approximately 15% to approximately 40%, especially approximately 20% to approximately 35%, and preferably approximately 25% to approximately 30% of the torque is transmitted to the two propellers at the corresponding rotational speed.

6. Ship propulsion unit according to one of the preceding claims, characterized in that the front transmission devices contain a front planetary gear and/or that the rear transmission devices contain a rear planetary gear.

7. Ship propulsion unit according to claim 6, characterized in that the front planetary gear and/or the rear planetary gear contain or contains gear reduction for achieving at least approximately the full torque on the corresponding propeller.

8. Ship propulsion unit according to claim 6 or 7, characterized in that the front planetary gear and/or the rear planetary gear have or has a gear reduction of approximately 2 to approximately 5, especially approximately 2.5 to approximately 4.5, and preferably approximately 3 to approximately 4.

9. Ship propulsion unit according to one of the preceding claims, characterized in that the front transmission devices contain a front ring gear and an associated front pinion gear, which is engaged with this front ring gear and which is coupled to the torque-transmitting shaft, and/or that the rear transmission devices contain a rear ring gear and an associated rear pinion gear, which is engaged with this rear ring gear and which is coupled to the torque-transmitting shaft.

10. Ship propulsion unit according to claim 9, characterized in that the front pinion gear and/or the rear pinion gear lie or lies on the torque-transmitting shaft.

11. Ship propulsion unit according to claim 10, characterized in that the front pinion gear and/or the rear pinion gear are or is locked in rotation with the torque-transmitting shaft.

12. Ship propulsion unit according to one of claims 9-11, characterized in that the front ring gear-front pinion gear pair and/or the rear ring gear-rear pinion gear pair contain or contains a gear reduction for achieving at least approximately the full torque on the corresponding propeller.

13. Ship propulsion unit according to claim 12, characterized in that the front ring gear-front pinion gear pair and/or the rear ring gear-rear pinion gear pair have or has a gear reduction from approximately 2 to approximately 5, especially approximately 2.5 to approximately 4.5, and preferably approximately 3 to approximately 4.

14. Ship propulsion unit according to one of the preceding claims, characterized in that the front transmission devices and the rear transmission devices are designed so that the two propellers rotate in the same direction.

15. Ship propulsion unit according to claims 1-13, characterized in that the front transmission devices and the rear transmission devices are designed so that the two propellers rotate in opposite directions.

16. Ship propulsion unit according to claims 1-13, characterized in that there are devices reversing the direction of rotation, by means of which the two propellers can be adjusted in terms of rotating in the same or opposite directions.

17. Ship propulsion unlit according to one of the preceding claims, characterized in that the front transmission devices and the real transmission devices are designed so that the two propellers rotate at different speeds.

18. Ship propulsion unit according to claim 17, characterized in that the front transmission devices and the rear transmission devices are designed so that the rear propeller rotates faster than the front propeller.

19. Ship propulsion unit according to one of the preceding claims characterized in that there are rotational speed control devices acting on at least one of the two propellers, by means of which a rotational speed ratio between the two propellers is adjustable.

20. Ship propulsion unit according to one of the preceding claims, characterized in that a differential gear is located between the torque-transmitting shaft and the two propellers.

21. Ship propulsion unit according to one of the preceding claims, characterized in that the two propellers have parallel or coaxial rotational axes which are at a non-90° angle to the vertical, so that the front propeller lies lower than the rear propeller.

22. Ship propulsion unit according to claim 21, characterized in that the smaller angle of the rotational axes of the two propellers to the vertical equals approximately 80° to approximately 89°, especially approximately 82° to approximately 87°, and preferably at least approximately 85°.

23. Ship propulsion unit according to one of the preceding claims, characterized in that the drive devices contain a high-temperature superconductor motor.

24. Ship propulsion method, wherein a front propeller and a rear propeller, which are assigned to an underwater pod located outside of the hull, are driven by drive devices in the hull via torque-transmitting devices, characterized in that the two propellers are driven by means of a torque-transmitting shaft, which is contained in the torque transmission devices and which is shared by both propellers, for transmitting torque from the drive devices into the underwater pod and by means of front transmission devices, which are arranged in the underwater pod and which are located between the shared torque-transmitting shaft of the two propellers and the front propeller, as well as rear transmission devices, which are located between the shared torque-transmitting shaft of the two propellers and the rear propeller.

25. Ship propulsion method according to claim 24, characterized in that via the torque-transmitting shaft, only a fraction of the torque is transmitted to the two propellers at the corresponding rotational speed.

26. Ship propulsion method according to claim 25, characterized in that via the torque-transmitting shaft, only approximately 15% to approximately 40%, especially approximately 20% to approximately 35%, and preferably approximately 25% to approximately 30% of the torque is transmitted to the two propellers at the corresponding rotational speed.

27. Ship propulsion method according to one of claims 24-26, characterized in that at least one ring gear-bevel gear pair is assigned to the torque-transmitting shaft for reversing the direction of rotation and that only a fraction of the torque is transmitted to the two propellers at the corresponding rotational speed via the one or more ring gear-bevel gear pairs.

28. Ship propulsion method according to claim 27, characterized in that via the one or more ring gear-bevel gear pairs, only approximately 15% to approximately 40%, especially approximately 20% to approximately 35%, and preferably approximately 25% to approximately 30% of the torque is transmitted to the two propellers at the corresponding rotational speed.

29. Ship propulsion method according to one of claims 24-28, characterized in that the front transmission devices contain a front planetary gear and/or that the rear transmission devices contain a rear planetary gear and that through the front planetary gear and/or the rear planetary gear a gear reduction is realized for achieving at least approximately the full torque on the corresponding propeller, and/or that through the front planetary gear and/or the rear planetary gear a gear reduction of approximately 2 to approximately 5, especially approximately 2.5 to approximately 4.5, and preferably approximately 3 to approximately 4 is realized.

30. Ship propulsion method according to one of claims 24-29, characterized in that the front transmission devices contain a front ring gear and an associated front pinion gear, which is engaged with this front ring gear and which is coupled to the torque-transmitting shaft, and/or that the rear transmission devices contain a rear ring gear and an associated rear pinion gear, which is engaged with this rear ring gear and which is coupled to the torque-transmitting shaft, and that the front pinion gear and/or the rear pinion gear lie or lies on the torque-transmitting shaft.

31. Ship propulsion method according to claim 30, characterized in that the front pinion gear and/or the rear pinion gear are rotated identically to the torque-transmitting shaft.

32. Ship propulsion method according to one of claims 30 or 31, characterized in that a gear reduction for delivering at least approximately the full torque to the corresponding propeller is realized by the front ring gear-front pinion gear pair and/or the rear ring gear-rear pinion gear pair.

33. Ship propulsion method according to claim 32, characterized in that a gear reduction of approximately 2 to approximately 5, especially approximately 2.5 to approximately 4.5, and preferably approximately 3 to approximately 4 is realized by the front ring gear-front pinion gear pair and/or the rear ring gear-rear pinion gear pair.

34. Ship propulsion method according to one of claims 24-33, characterized in that the front transmission devices and the rear transmission devices are designed so that the two propellers rotate in the same direction.

35. Ship propulsion method according to one of claims 24-33, characterized in that the front transmission devices and the rear transmission devices are designed so that the two propellers rotate in opposite directions.

36. Ship propulsion method according to one of claims 24-33, characterized in that there are devices for reversing the direction of rotation acting on at least one of the two propellers by means of which the two propellers can be adjusted in terms of rotating in the same or opposite directions.

37. Ship propulsion method according to one of claims 24-36, characterized in that the front transmission devices and the rear transmission devices are designed so that the two propellers rotate at different speeds.

38. Ship propulsion method according to claim 37, characterized in that the front transmission devices and the rear transmission devices are designed so that the rear propeller rotates faster than the front propeller.

39. Ship propulsion method according to one of claims 24-38, characterized in that there are rotational speed control devices, which act on at least one of the two propellers and by means of which a rotational speed ratio between the two propellers is set.

40. Ship propulsion method according to one of claims 24-39, characterized in that a differential gear, through which the different rotational speeds between the front propeller and the rear propeller are set, is located between the torque-transmitting shalt and the two propellers.

41. Ship propulsion method according to one of claims 24-40, characterized in that the two propellers have parallel or coaxial rotational axes, which are at a non-90° angle to the vertical, so that the front propeller lies lower than the rear propeller.

42. Ship propulsion method according to claim 41, characterized in that the smaller angle of the rotational axes of the two propellers to the vertical equals approximately 80° to approximately 89°, especially approximately 82° to approximately 87°, and preferably at least approximately 85°.

43. Ship propulsion method according to one of the preceding claims, characterized in that drive devices contain a high-temperature superconductor motor, through which the torque-transmitting shaft is driven.
